(19) United States
(12) Patent Application Publication
(10) Pub. No.: US 2024/0160838 A1
(43) Pub. Date: May 16, 2024

(54) System and Methods for Enabling User Interaction with Scan or Image of Document

(71) Applicant: Evisort Inc., San Francisco, CA (US)

(72) Inventors: Amine Anoun, San Francisco, CA (US); Andrew Johnson, Chicago, IL (US); Jacob Sussman, Henderson, NV (US); Jerry Ting, Henderson, NV (US); Riley Hawkins, Austin, TX (US); Derek Peterson, Toronto (CA)

(21) Appl. No.: 18/388,991

(22) Filed: Nov. 13, 2023

Related U.S. Application Data
(60) Provisional application No. 63/425,544, filed on Nov. 15, 2022.

(51) Int. Cl. G06F 40/166; G06V 30/148; G06V 30/412; G06V 30/414; G06V 30/416

(52) U.S. Cl. CPC G06F 40/166; G06V 30/158; G06V 30/412; G06V 30/414; G06V 30/416

(57) ABSTRACT

A method for enabling a user to select and interact with text, lines, or paragraphs of a document, in the case where the document is available as a PDF or image. Embodiments enable the representation of a document to go beyond simple extraction of text, including organizing the text into logical groups of benefit to a user, such as paragraph, header, footer, or table (as examples), and labelling them as such. This facilitates subsequent processing, including application of machine learning (ML) algorithms to leverage this explicit information.

### CROSS REFERENCE TO RELATED APPLICATION

This application claims the benefit of U.S. Provisional Application No. 63/425,544, filed Nov. 15, 2022, entitled “System and Methods for Enabling User Interaction with Scan or Image of Document”, the disclosure of which is incorporated, in its entirety (including the Appendix) by this reference.

### BACKGROUND

Artificial Intelligence (AI) techniques are commonly becoming used in situations where a large amount of information needs to be examined and processed to identify or classify specific facts or situations. These AI techniques include the use of convolutional neural networks for image recognition or classification of documents and the use of trained neural networks to generate word embeddings for use in natural language processing (NLP) and natural language understanding (NLU). In some use cases, a trained machine learning (ML) model may be used to classify a document or section of a document with regards to its function or contents.

One area in which such techniques have been found to be useful is that of reviewing documents for purposes of identifying specific information. The information can be presented as topics, clauses, sections, paragraphs, phrases, sentences, or other forms of organizing information in a document. This type of document review can be helpful in legal processes such as discovery, contract drafting, drafting wills and other personal documents, and the drafting of documents that have unique requirements. It can also be used for purposes of document management, contract monitoring, contract analytics, and other functions that are based on identifying, extracting, and processing the contents of multiple documents.

In the example use case of drafting a contract, although certain terms or clauses are standard and found in most contracts (e.g., choice of law, incorporation of an entire agreement, general warranties, certain licensing terms, etc.), each industry and even each party to a contract may have specific requirements for an agreement. For example, even within the same industry, different vendors may have different required terms or clauses based on their form of incorporation, tax status, location, or method of operating their business. Further, over time a party may want to add, delete, or modify the terms and clauses they use in a contract. As a result, the terms, clauses, and interpretation of a contract may be specific to an industry or to an entity.

In this situation, a user may need to search for a specific term across hundreds of pages of documents. However, this ability may be limited, as scanned PDF files are not searchable, leaving the user either to miss examples or to need to invest substantial resources into a time-consuming human review.

One of the tools used in the application of AI techniques to document processing is a machine learning (ML) model. Such a model is “trained” using example data and labels so that it “learns” how to efficiently associate input data (termed “features”) with the correct or expected output. The output may be a category, an indication of the presence or absence of a characteristic, a specific value or term, metadata, or other information about a document.

However, performing an evaluation or analysis of a written document can be more difficult if the document is only available as a PDF or image of the document. In such cases, it may not be possible to identify attributes or features of the document or enable a user to select and interact with text, lines, or paragraphs of the document. This is because many NLP, NLU, or ML models that might be used as part of analyzing a document rely on text as their primary input, and for a PDF file, this information is not always available. This is because a PDF can be considered text-agnostic in that it stores data as a series of pixels, which only encode visual information. This also directly impacts the end user, as when a file lacks an explicit text layer, the user cannot perform even the basic action of searching the document for a certain word.

Although some conventional approaches to optical character recognition (OCR) are available to solve part of this problem, they lack certain desirable features of the approach disclosed and/or described herein. OCR systems generally return the text and bounding boxes that represent the location of the text, but they do not generate a version of the original document with the text presented in a way that a user can interact with the text. This is a disadvantage, as the original version of a document often contains rich and relevant information, such as in-document images, formatting including changes in font color, font type, and boldface, or signatures that OCR may not have captured, as non-limiting examples.

Implementing the functionality to enable a user to interact with the text in a document is non-trivial because various edge cases need to be accounted for and mistakes can surface to the user. For example, OCR systems are not perfect, so bounding boxes do not always have an appropriate position with the text they represent. If this misalignment is not detected and corrected, the user may search for a given word, and see a completely different word highlighted as the search result. Furthermore, a practical system should detect whether any pages already have a text layer, so as not to return a page with two text layers, which may also prevent the normal function of features such as text highlighting and search.

In addition, even once text has been extracted from a document by a traditional OCR system, that information is unstructured and of limited utility. This prevents a user from being able to recognize and interact with various sections or structures within a document, and as a result, limits the value of the extracted text.

What is desired are systems, apparatuses, and methods for processing a PDF or image of a document to enable a user to select and interact with text, lines, or paragraphs of the document. In some embodiments, this is accomplished by overlaying the text layer in situ to enable a user to leverage all the information contained in an original document while benefiting from the ability to interact with the text layer, such as by conducting a search. Embodiments of the disclosure address this and other objectives both individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

In some embodiments, the systems, apparatuses, and methods disclosed herein are directed to systems, methods, and apparatuses for enabling a user to select and interact with text, lines, or paragraphs of a document, in the case where the document is available as a PDF or image. This functionality can enable a user to efficiently find and utilize information contained in documents for which only a scan or PDF is available, and which otherwise may not be able to be processed and used as efficiently or effectively.

Embodiments of the approach disclosed and/or described herein enable the representation of a document to go beyond simple extraction of text, including organizing the text into logical groups of benefit to a user, such as paragraph, header, footer, or table (as examples), and labelling them as such. This facilitates subsequent processing, including application of machine learning (ML) algorithms to leverage this explicit information, and in some cases use of processed documents as part of training a model.

In one embodiment, the disclosure is directed to a method for enabling a user to select and interact with text, lines, or paragraphs of a document, in the case where the document is available as a PDF or image. In one non-limiting use case, the documents may be contracts as an example. In one embodiment, the method may include the following steps, stages, or operations:
Perform OCR (optical character recognition) on PDF file or document scan to identify text in the document, and identify bounding boxes (a rectangle that surrounds an object, specifies its position, its class (e.g., car, person) and a confidence level (how likely the text is to be at that location)) for words and lines of that text;
Overlay the text output by the OCR process on top of the original document image (PDF/scan) and make that layer invisible to a user. This may comprise one or more of the following steps, stages, processes, functions, or operations:
   Converting one or more pages into an image representation;
   Computing and apply a scaling factor (if needed) between the image representation and the document scan;
   Identifying and applying a font size and/or type to the text;
   Assembling the text into a layer and overlaying the layer on the PDF or document scan, and making the overlay (substantially) invisible to the user;
      In one embodiment, this is done by positioning each word at the coordinate it was extracted from in each page and applying the inferred font size. The text can be positioned and made invisible using a library such as Reportlab in Python;
Identify one or more paragraphs in the document by grouping a series of lines together into a paragraph (in some cases, this may not be needed if the OCR scan and associated processing can provide the information). This may comprise one or more of the following steps, stages, processes, functions, or operations:
   Identify spacing between lines and determine most likely breaks between sections of the document or paragraphs;
   Identify enumerators (such as indications of formats, outlines, or paragraph or line numbers, as non-limiting examples);
   Use the identified breaks and/or enumerators to identify paragraphs in the document;
   If desired, detect headers and/or footers based on position, format, and/or contents;
   Identify and if desired, extract elements such as clause titles and tables for further processing and analysis using one or more of positional and semantic analysis or models (as disclosed and/or described further herein);
      For example, clause title extraction can be performed using a Named Entity Recognition (NER) model such as bi-LSTM, where each character, word and/or phrase is embedded, and passed into a deep learning model that learns what constitutes a clause title based on labeled training data;
Generate and populate a structured document object;
   As a non-limiting example, the document object can be represented in a JSON format that's flexible enough to add attributes such as paragraph headers or tables (as examples); and
Provide the processed document to user and/or document processing pipeline for further evaluation and analysis;
   This may include generating a display of the processed document to enable a user to interact with the document by selecting an element of the document, annotating an element, or perform another action.

In one embodiment, the disclosure is directed to a system for enabling a user to select and interact with text, lines, or paragraphs of a document (as examples), in the case where the document is available as a PDF or image. The system may include a set of computer-executable instructions stored in (or on) a memory or data storage element (such as a non-transitory computer-readable medium) and one or more electronic processors or co-processors. When executed by the processors or co-processors, the instructions cause the processors or co-processors (or a device of which they are part) to perform a set of operations that implement an embodiment of the disclosed method or methods.

In one embodiment, the disclosure is directed to a non-transitory computer readable medium containing a set of computer-executable instructions, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to a user, set of users, an entity, a set or category of entities, a set or category of users, a set or category of documents, an industry, or an organization, for example. Each account may access one or more services, a set of which are instantiated in their account, and which implement one or more of the methods or functions disclosed and/or described herein.

Other objects and advantages of the systems, apparatuses, and methods disclosed may be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in detail herein. However, embodiments of the disclosure are not limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1 is a diagram illustrating a process, method, operation, or function that may be performed in an implementation of an embodiment of the disclosed system and methods;

FIG. 2 is a diagram illustrating elements or components that may be present in a computing device or system configured to implement a method, process, function, or operation in accordance with some embodiments of the systems, apparatuses, and methods disclosed herein; and

FIGS. 3-5 are diagrams illustrating an architecture for a multi-tenant or SaaS platform that may be used in implementing an embodiment of the systems and methods disclosed herein.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among others, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods disclosed and/or described herein may be implemented by one or more suitable processing elements (such as a processor, microprocessor, co-processor, CPU, GPU, TPU, QPU, or controller, as non-limiting examples) that is part of a client device, server, network element, remote platform (such as a SaaS platform), an “in the cloud” service, or other form of computing or data processing system, device, or platform.

The processing element or elements may be programmed with a set of computer-executable instructions (e.g., software instructions), where the instructions may be stored in (or on) one or more suitable non-transitory data storage elements or media. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, the systems and methods disclosed herein may provide services through a SaaS or multi-tenant platform. The platform provides access to multiple entities, each with a separate account and associated data storage. Each account may correspond to a user, set of users, an entity, a set or category of entities, a set or category of users, a set or category of documents, an industry, or an organization, for example. Each account may access one or more services, a set of which are instantiated in their account, and which implement one or more of the methods or functions described herein.

In some embodiments, one or more of the operations, functions, processes, or methods described herein may be implemented by a specialized form of hardware, such as a programmable gate array, application specific integrated circuit (ASIC), or the like. An embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

In some embodiments, the disclosure is directed to systems, methods, and apparatuses for enabling a user to select and interact with text, lines, or paragraphs of a document, in the situation where the document is available as a PDF or image. This functionality can enable a user to efficiently find and utilize information contained in documents for which only a scan or PDF is available, and which otherwise may not be able to be processed and used as efficiently or effectively.

Embodiments of the approach disclosed and/or described herein enable the representation of a document to go beyond simple extraction of text, including organizing the text into logical groups of benefit to a user, such as paragraph, header, footer, or table (as examples), and labelling them as such. This facilitates subsequent processing, including application of machine learning (ML) algorithms to leverage this explicit information, and in some cases use of processed documents as part of training a model.

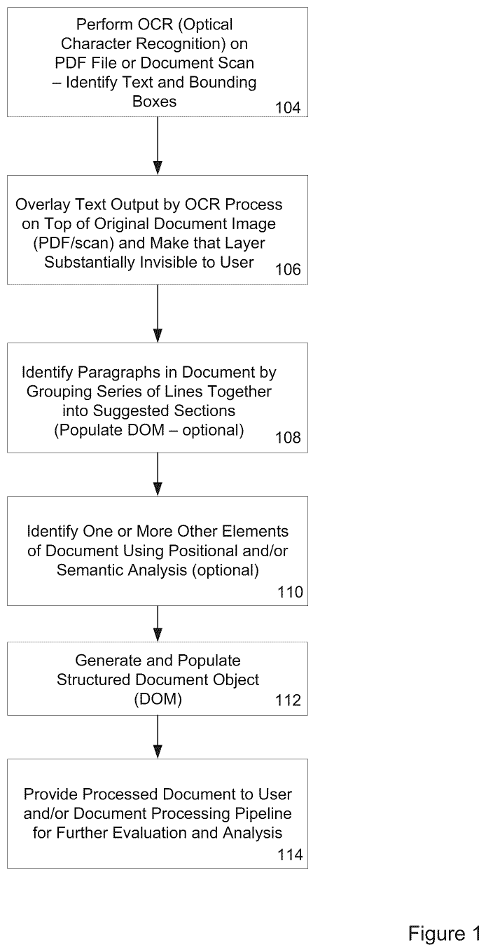

FIG. 1 is a diagram illustrating a process, method, operation, or function that may be performed in an implementation of an embodiment of the disclosed system and methods. As shown in the figure, an embodiment may comprise one or more of the following steps or stages:
Perform OCR (optical character recognition) on a PDF file or document scan (as suggested by step or stage 104);
   Based on OCR processing, identify text in the document, and identify bounding boxes for words and lines of that text;
Overlay the text output by the OCR process on top of the original document image (the PDF/scan) and make that layer substantially invisible to a user (as suggested by step or stage 106). In one embodiment, this may comprise one or more of the following steps or stages:
   Converting one or more pages into an image representation;
   Computing and apply a scaling factor (if needed) between the image representation and the document scan;
   Identifying and applying a font size and/or type to the text;
   Assembling the text into a layer and overlaying the layer on the PDF or document scan, and making the overlay substantially invisible to a user;
Identify paragraphs in the document by grouping a series of lines together into a suggested section and at this stage and/or later, populate a structured document object (DOM) (as suggested by step or stage 108, although as mentioned, in some cases, this may not be needed if the OCR scan and associated processing can provide the information). In one embodiment, this may comprise one or more of the following steps or stages:
   Identify spacing between lines and determine most likely breaks between sections of the document or groups of text;
   Identify enumerators in document;
   Use the identified breaks and/or enumerators to identify possible paragraphs in the document;
   If desired, detect headers and/or footers based on position and/or semantic analysis of contents (as suggested by step or stage 110);
   Identify and if desired, extract elements such as clause titles and tables for further processing and analysis using one or more of positional and semantic analysis or models (as suggested by step or stage 110, and as disclosed and/or described further herein); and
Generate and populate a structured document object/model (DOM) (as suggested by step or stage 112);
   In one embodiment, this may take the form of a model or data structure containing document elements and indicating a relationship between the elements; and
Provide processed document to user and/or document processing pipeline for further evaluation and analysis (as suggested by step or stage 114);
   This may include generating a display of the processed document to enable a user to interact with the document by selecting an element of the document, annotating an element, or performing another action.

In some embodiments, a document object (DOM) as used herein is explicitly structured. Its structure is pre-defined and regular, and so can be queried or transformed to/from a Json format. It may include or be associated with elements or characteristics such as a unique identifier, a type (i.e., a role it plays in the text), the coordinates of its location, a page number, and pointers to child or related elements (such as individual words), as non-limiting examples.

As a non-limiting example, in one embodiment, a DOM would contain the text of the document, split into words, sentences, and paragraphs; as well as attributes for each of the text splits, such as their bounding box coordinates, language, font size and font type if available, and nature (e.g., paragraph header, table cell, watermark, header, footer, or table of contents, as examples). The DOM is used for backend processing (e.g., as an input to downstream AI models that need to understand the text and structure of the document) but is not provided to the end-user. However, the processed document (original document with the text overlay) is provided to the user through the application.

In one example embodiment, the disclosed and/or described processing leverages a third-party OCR API, which handles many foreign languages, including handwritten text for English and additional languages. This provides the disclosed system with the text in the document, and the bounding boxes¹ for that text. While the third-party OCR API provides bounding boxes for individual words and individual lines, it does not provide bounding boxes for paragraphs and other potentially important features. ¹ A bounding box is a set of x and y coordinates that defines the location of a piece of text in the original Document.

As disclosed, the bounding boxes can be used to enable text search and highlighting on the original document. In one embodiment, an approach is to overlay the text output by the OCR model on top of the original document and to make this new “layer” substantially invisible. The result is that visually the document is identical (or nearly so) to its original form, but a user can now interact with it.

In one embodiment, a mechanism to accomplish this result involves taking the bounding box coordinates from OCR, inferring the font size, and using the Python library ReportLab (as an example) to add this text on top of the original text. Although the overlaid text can be set to be substantially invisible (or apparent but not in a way that causes confusion between it and the original text), the file recognizes it as present, so a user is able to highlight it, search it, copy it, or perform other desired actions. Further, because it overlaps with the original text, from the viewpoint of the user, it may seem as if they are performing these actions on the original text itself.

The following is a more detailed description of one example of a processing flow for implementing the disclosed approach of creating an interactive “invisible” or “substantially invisible” layer:
Use the pdf2image library to convert pages to an image representation, so they can be manipulated visually and serve as a backdrop for the invisible text layer. To avoid unnecessary processing time, it is beneficial to first detect/determine which pages within a document should be converted and process only those pages. To determine this, it is possible to use the PyPDF2 library, which functions to read in a pdf file and search for text within it. When no text can be detected on a page (e.g., because it is a scanned document), the process determines that it requires image conversion;
After conversion with pdf2image, the page is proportional to the original, but as an artifact of the library, its exact dimensions may vary. Therefore, the process may compute the scaling factor by which these differ and apply it to the bounding box coordinates to ensure proper overlap;
The OCR API does not return information on font type or font size. Because the added layer is (substantially) invisible, there is no need for an exact stylistic match, but it is beneficial to approximate the size and spacing of the original font to ensure optimal overlap and reduce possible confusion. To this end, in one embodiment, the process uses the Noto Sans font², which is both open source and designed to cover writing systems beyond just the Latin alphabet. The font size is inferred using an algorithm based on a binary search, and is described in greater detail below;
   The algorithm to infer font size operates to “match” the overlaid text as closely as possible in size to the original text. From the OCR step, the process has a bounding box that outlines the dimensions of the original text. That box can be used to determine the width of the original text;
   The algorithm searches through different potential font sizes for the overlaid text. It tries out a given font size to see how closely it measures to the width of the original. Once it is within a certain threshold of closeness without going over, that font size is set for the overlaid text. In one embodiment, the method for searching through possible font sizes is a binary search, which uses an established search paradigm in computer science, and is used because it is more efficient than more naive approaches³;
Some bounding boxes appear at an angle on the page. This angle may be detected, and in response an adjustment may be made to the invisible layer's bounding box, so that it is aligned with the original. ² https://fonts.google.com/noto/specimen/Noto+Sans.³ https://www.khanacademy.org/computing/computer-science/algorithms/binary-search/a/binary-search.

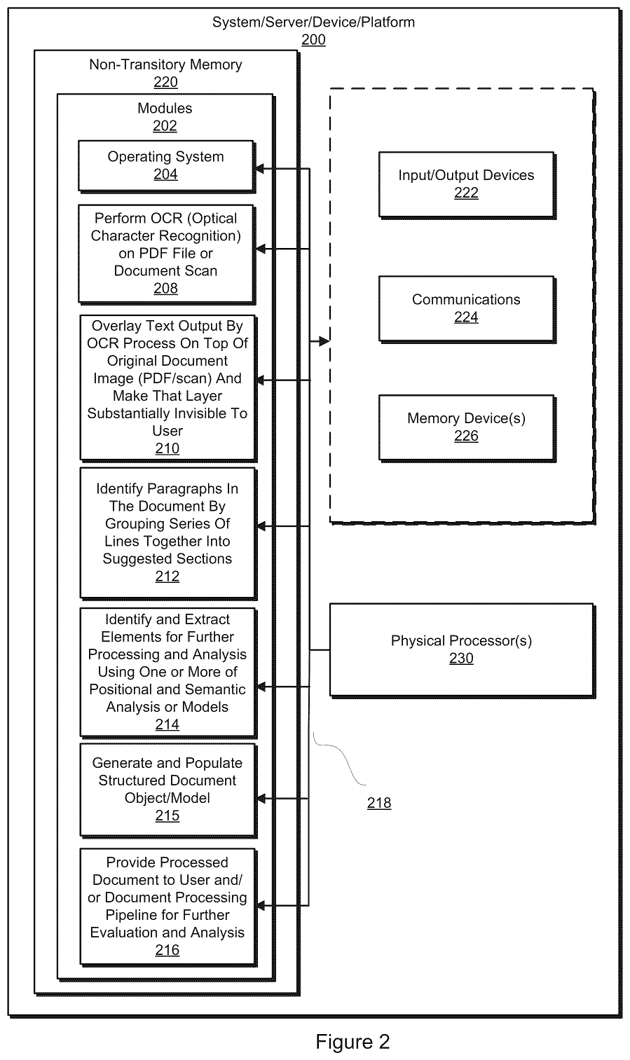

FIG. 2 is a diagram illustrating elements or components that may be present in a computing device or system configured to implement a method, process, function, or operation in accordance with an embodiment of the system and methods disclosed herein. As noted, in some embodiments, the system and methods may be implemented in the form of an apparatus that includes a processing element and a set of computer-executable instructions. The executable instructions may be part of a software application and arranged into a software architecture.

In general, an embodiment may be implemented using a set of software instructions that are designed to be executed by a suitably programmed processing element (such as a GPU, CPU, TPU, QPU, microprocessor, processor, co-processor, or controller, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

Each module or sub-module may correspond to a particular function, method, process, or operation that is implemented by the module or sub-module. Such function, method, process, or operation may include those used to implement one or more aspects of the disclosed systems, apparatuses, and methods.

The modules and/or sub-modules may include a suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

The modules or sub-modules may contain one or more sets of computer-executable instructions for performing a method, operation, process, or function described with reference to the Figures, and/or disclosed in the specification. These modules or sub-modules may include those illustrated but may also include a greater number or fewer number than those illustrated. As mentioned, each module or sub-module may contain a set of computer-executable instructions. The set of instructions may be executed by a programmed processor contained in a server, client device, network element, system, platform, or other component.

A module or sub-module may contain instructions that are executed by a processor contained in more than one of a server, client device, network element, system, platform, or other component. In some embodiments, a plurality of electronic processors, with each being part of a separate device, server, platform, or system may be responsible for executing all or a portion of the software instructions contained in an illustrated module or sub-module. Thus, although FIG. 2 illustrates a set of modules which taken together perform multiple functions or operations, these functions or operations may be performed by different devices or system elements, with certain of the modules (or instructions contained in those modules) being associated with those devices or system elements.

As shown in FIG. 2, system 200 may represent a server or other form of computing or data processing system, platform, or device. Modules 202 each contain a set of computer-executable instructions, where when the set of instructions is executed by a suitable electronic processor or processors (such as that indicated in the figure by “Physical Processor(s) 230”), system (or server, platform, or device) 200 operates to perform a specific process, operation, function, or method.

Modules 202 are stored in a (non-transitory) computer-readable memory 220, which typically includes an Operating System module 204 that contains instructions used (among other functions) to access and control the execution of the instructions contained in other modules. The modules 202 stored in memory 220 are accessed for purposes of transferring data and executing instructions by use of a “bus” or communications line 218, which also serves to permit processor(s) 230 to communicate with the modules for purposes of accessing and executing a set of instructions. Bus or communications line 218 also permits processor(s) 230 to interact with other elements of system 200, such as input or output devices 222, communications elements 224 for exchanging data and information with devices external to system 200, and additional memory devices 226.

For example, Modules 202 may contain computer-executable instructions which when executed by a programmed processor cause the processor or a device in which it is implemented to perform the following process, method, function, or operation:
Perform OCR (Optical Character Recognition) on PDF file or document scan (as suggested by module 208);
   Based on OCR processing, identify text in the document, and identify bounding boxes for words and lines of that text;
Overlay the text output by the OCR process on top of the original document image (PDF/scan) and make that layer (substantially) invisible to a user (module 210). In one embodiment, this may comprise:
   Converting one or more pages into an image representation;
   Computing and apply a scaling factor (if needed) between the image representation and the document scan;
   Identifying and applying a font size and/or type to the text;
   Assembling the text into a layer and overlaying the layer on the PDF or document scan, and making the overlay (substantially) invisible to a user;
Identify paragraphs in the document by grouping a series of lines together into a suggested section and at this stage and/or later, populate a structured document object (DOM) (as suggested by module 212, although as mentioned, in some cases, this may not be needed if the OCR scan and associated processing can provide the information). In one embodiment, this may comprise one or more of the following steps or stages:
   Identify spacing between lines and determine most likely breaks between sections of the document or groups of text;
   Identify enumerators in document;
   Use the identified breaks and/or enumerators to identify possible paragraphs in the document;
   If desired, detect headers and/or footers based on position and/or semantic analysis of contents (optional, module 214);
   Identify and if desired, extract elements such as clause titles and tables for further processing and analysis using one or more of positional and semantic analysis or models (optional, module 214);
Generate and populate a structured document object/model (DOM) (module 215);
   In one embodiment, this may take the form of a model or data structure containing document elements and indicating a relationship between the elements; and
Provide processed document to user and/or document processing pipeline for further evaluation and analysis (module 216);
   This may include generating a display of the processed document to enable a user to interact with the document by selecting an element of the document, annotating an element, or performing another action.

As mentioned, users benefit when they can interact with a document file by searching for a term or by selecting a term within the text for the purpose of highlighting or in situ data annotation (e.g., by using Ctrl+F). This can be done natively on docx files and certain pdf files, but not on pdf files containing a scan or image of an original document. Embodiments of the disclosure provide this functionality and capability for such documents.

In some embodiments, this is accomplished by generating a structured representation of the contents of a document. This may be needed because raw text from a document or OCR system is typically unstructured. That is, there is no explicit organization or labeling to complement an extracted series of words. Embodiments generate a document object (DOM), which serves as a foundation for adding structure, such as linking paragraphs that are split across page breaks, or identifying lists, headers, or footers, as non-limiting examples.

In some embodiments, a process referred to as Document Layout Analysis herein may be performed to assist in identifying elements or structures in a block of text. In one example, this processing flow or component may be used to add structure to raw text and group a set of lines together into one or more paragraphs. As mentioned, some OCR API's may perform this function, providing paragraph chunking information along with the original text and its bounding boxes. However, other OCR processes that may excel in accuracy, latency, cost, and/or other functions, typically lack this feature. In such cases, it becomes necessary to develop an alternative approach. Combination approaches are also possible, such as one in which the API-provided paragraphs are used by default, but the alternative approach is used to verify or correct that output.

When performed by a separate process (i.e., other than the OCR processing), the document layout analysis may be done using a combination of semantic (i.e., text-based) and positional (i.e., location, bounding box-based) features or characteristics. For this reason, the output of the OCR API is needed. However, Document Layout Analysis is independent from PDF Preview, so the two can be performed in parallel, with a single call to the OCR API being used as inputs for both. An outcome/output of this step is a structured document object, which can be converted into/from a Json representation and to which additional structure can later be added modularly, as described in the following non-limiting example:
Assume a user wants to mark which segments of text in a document represent a table. This may be done by treating the processing to detect a table as a black box that indicates or classifies an object as either a table or not a table:
   The process could either execute this detection/classification process during the initial pass of the Document Layout Analysis processing, or later as a post-processing step. Regardless of the implementation, once a segment of text has been identified as a table, that information can be added to the document object, for example, by changing its “type” to “table”. The creation of a document object representation allows the addition and storage of new categories and information relevant to a document.

As mentioned, in some embodiments, one or more of positional logic and semantic logic may be used to assist the processing flow to identify specific features or characteristics of text in a document. Examples of these processes or functions are described in greater detail in the following:
Positional Logic: OCR typically returns lines in their “natural reading order”. Based on the bounding box coordinates, further processing can determine the vertical distance between a line and the following one. Then for each page, using the distribution of line “gaps”, an algorithm can be used to determine a spacing threshold value for that page. By default, adjacent lines below this threshold value are grouped into the same “chunk”, which typically corresponds to a paragraph, while lines with spacing above this threshold are grouped separately;
   A way to determine the start of a new paragraph (or other meaningful chunk of text) is by it being spaced further from adjacent lines. However, this is a relative aspect. While a double space on an otherwise tightly single-spaced page can be a suggestion or indication of a new paragraph, in terms of absolute distance, it might be similar to an innocuous line gap on a completely double-spaced page;
   Therefore, to provide greater reliability and confidence in the result, in one embodiment, the processing examines the distribution of line gaps over an entire page to determine what gap value is “normal” and does not constitute a new paragraph. This is done on a page-by-page basis to determine how to segment a page into paragraphs or related groupings;
As an example, the processing obtains all the distances or separations from one line to the next line on a page. These values are then sorted in order. Assume it is found that the gaps typically cluster around a value or small range of values. For example, with 5 single-spaced lines and 2 double-spaced lines, the sorted gaps might look something like [0.23, 0.23, 0.25, 0.25, 0.26, 0.51, 0.52]. The process detects that there is an open interval or “gap” in this set of gaps from 0.26 to 0.51, and so the threshold may be set to be a value between those two values;
Semantic Logic: A possible source of error is when a list of entries is incorrectly combined due to the proximity of its lines. In one embodiment, explicit logic may be defined to detect/identify enumerators between sections (e.g., A, B, C; i, ii, iii; 1, 2, 3) and to split the text at such an indicator. To avoid over-splitting, specific conditions may be set, such as the enumerator being present near the beginning of the line and being the next increment or value of a previously identified enumerator. For example, in one embodiment, the following processing flow may be used for this purpose:
   Step 1: For each line, identify a candidate enumerator by searching the first several words for certain indicia or patterns, including numbers, single letters of the alphabet, or roman numerals, as non-limiting examples. Filter out what are likely false positives, such as numbers belonging to a street address or date;
      Note that the process does not care about enumerators beyond the first few words of a line, because they are more likely to be in-line references that the process does not want to use as a basis for splitting text (e.g., “We observed in Section B that this was true.”);
   Step 2: Even if an enumerator is detected, the process does not necessarily split the text, because this may result in over-splitting due to false positives. Therefore, the process maintains a running record of the previous enumerators that were identified on a page and generates the enumerators that would be expected to follow. For example, if “i” was extracted, “ii” or “j” would be potential next enumerators; similarly, for “1.9”, possibilities for a next enumerator include “2.0”, “1.10”, and “1.9.1”;
   Using this set of logic, rules, or heuristics, the process operates to split text at an enumerator when one of the following conditions are met:
      a) The enumerator is the next increment of a previously detected enumerator;
      b) The enumerator is a valid “starting” enumerator (e.g., “A”, “1”, “1”); or
      c) The enumerator occurs very early in the page and is likely a continuation of an in-progress list from the previous page.

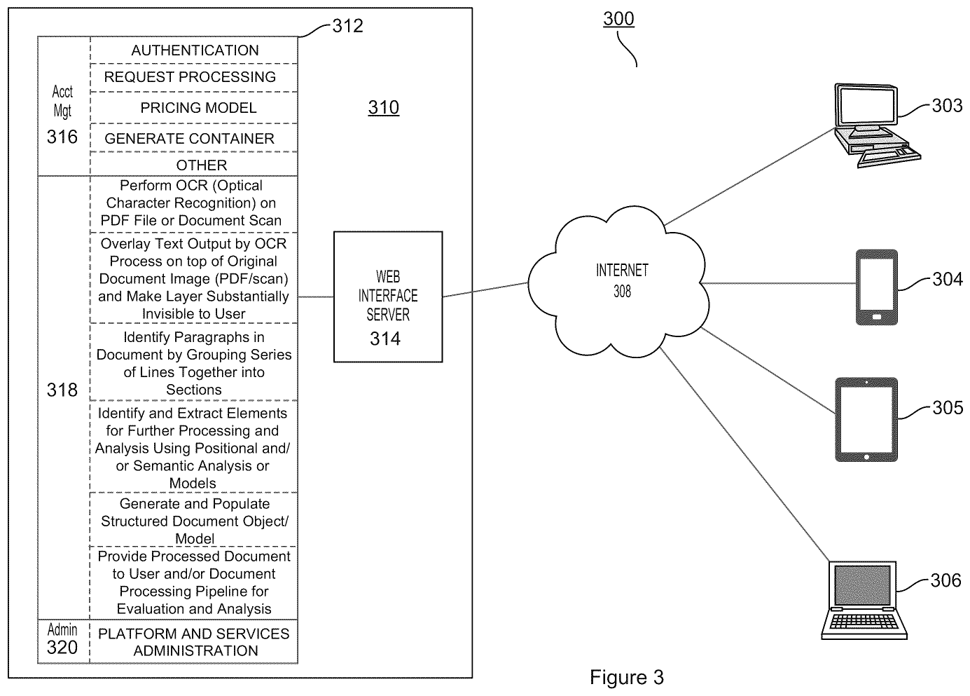

As mentioned, in some embodiments, the systems and methods disclosed herein may provide services through a SaaS or multi-tenant platform. The platform provides access to multiple entities, each with a separate account and associated data storage. Each account may correspond to a user, set of users, an entity, a set or category of entities, a set or category of users, a set or category of documents, an industry, or an organization, for example. Each account may access one or more services, a set of which are instantiated in their account, and which implement one or more of the methods or functions disclosed and/or described herein. FIGS. 3-5 are diagrams illustrating an architecture for a multi-tenant or SaaS platform that may be used in implementing an embodiment of the disclosed and/or described systems and methods.

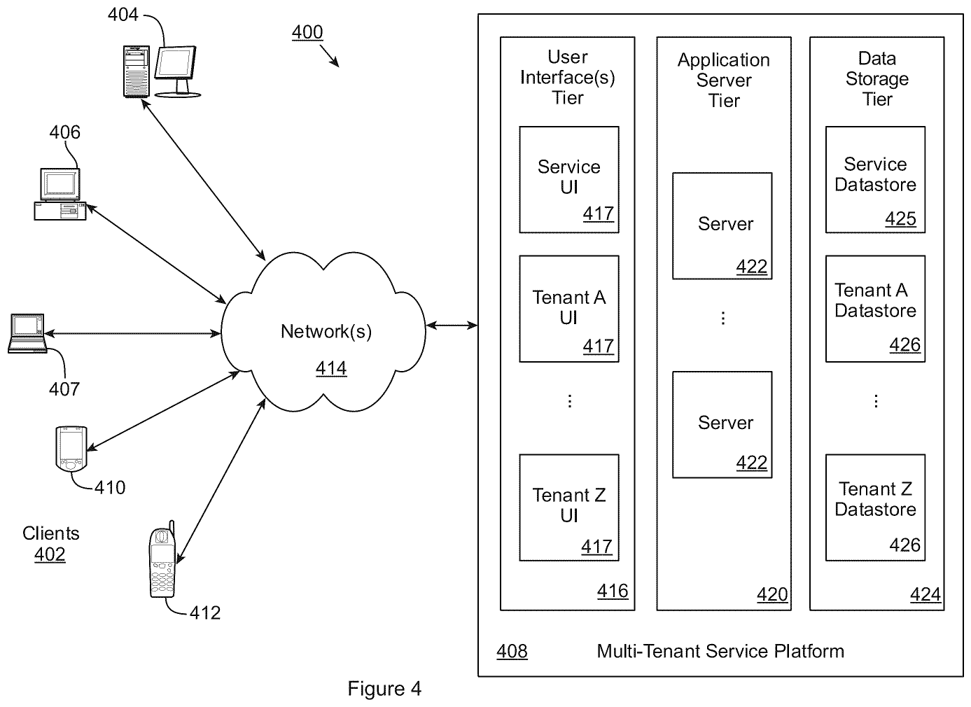

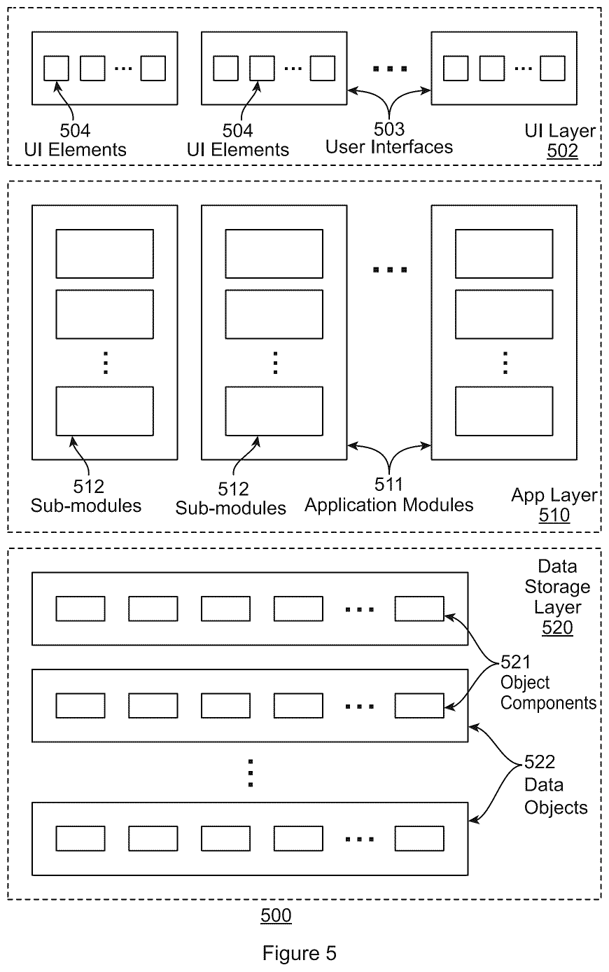

FIG. 3 is a diagram illustrating a SaaS system in which an embodiment of the disclosure may be implemented. FIG. 4 is a diagram illustrating elements or components of an example operating environment in which an embodiment of the disclosure may be implemented. FIG. 5 is a diagram illustrating additional details of the elements or components of the multi-tenant distributed computing service platform of FIG. 4, in which an embodiment of the disclosure may be implemented.

In some embodiments, the system or service(s) disclosed and/or described herein may be implemented as micro-services, processes, workflows, or functions performed in response to requests. The micro-services, processes, workflows, or functions may be performed by a server, data processing element, platform, or system. In some embodiments, the services may be provided by a service platform located “in the cloud”. In such embodiments, the platform is accessible through APIs and SDKs.

The described document processing and evaluation services may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the document processing and evaluation processes disclosed and/or described herein.

Although in some embodiments, a platform or system of the type illustrated in FIGS. 3-5 and the associated services may be operated by a 3^{rd} party provider, in other embodiments, the platform may be operated by a provider and a different source may provide the applications or services for users through the platform.

FIG. 3 is a diagram illustrating a system 300 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, stores, or organizations, as non-limiting examples. A user may access the services using a suitable client, including but not limited to desktop computers, laptop computers, tablet computers, scanners, or smartphones. In general, a client device having access to the Internet may be used to provide a request or text message requesting a service (such as the processing of a document). Users interface with the service platform across the Internet 308 or another suitable communications network or combination of networks. Non-limiting examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. Either or both of services 312 and the web interface server 314 may be implemented on one or more different hardware systems and components, even though represented as singular units in FIG. 3. Services 312 may include one or more functions or operations for the processing of a document, creating a layer containing text, identifying one or more elements or structures of the document, and presenting the processed PDF or document scan to a user for selection and/or interaction with text, lines, or paragraphs of the document, as non-limiting examples.

In some embodiments, the set of applications or services available to a user may include one or more that perform the functions and methods disclosed and/or described herein. As examples, in some embodiments, the set of applications, functions, operations or services made available through the platform or system 310 may include:
account management services 316, such as
   a process or service to authenticate a person or entity requesting document processing services (such as credentials, proof of purchase, or verification that the customer has been authorized by a company to use the services provided by the platform);
   a process or service to receive a request for processing of a PDF or document scan;
   an optional process or service to generate a price for the requested service or a charge against a service contract;
   a process or service to generate a container or instantiation of the requested processes for a user/customer, where the instantiation may be customized for a particular company or account; and
   other forms of account management services;
a set of processes or services 318 for processing a PDF or document scan to enable further processing of a document and user interaction with elements of the document, such as:
   a process or service that performs OCR (optical character recognition) on a PDF file or document scan;
   a process or service that overlays text output by the OCR process on top of the original document image (PDF/scan) and makes that layer substantially invisible to a user;
      in some use cases, it may be possible to make the overlaid layer visible, but less (or un-) obtrusive to a user;
   a process or service that identifies paragraphs in a document by grouping series of lines together into a section (this is optional, and may not be needed if OCR and associated processing can perform this function or its equivalent);
   a process or service that identifies and extracts elements for further processing and analysis using one or more of positional and semantic analysis or models;
      where such models may analyze or evaluate location, or a measurement of size or spacing between elements, and/or infer a meaning or sequencing of an element (such as an enumerator, footnote, or other element); and
   a process or service to provide the processed document to a user and/or document processing pipeline for further evaluation and analysis;
      as non-limiting examples, such further processing or evaluation may include one or more of the following:
         selecting an element of the document;
         annotating an element;
         labeling an element;
         commenting on a portion of the document;
         searching for a specific word of phrase within the document;
         highlighting the source of AI outputs (e.g., extracted metadata, answers in a conversational interface) in the document;
administrative services 320, such as
   a process or services to enable the provider of the document processing and services and/or the platform to administer and configure the processes and services provided to users.

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server (as examples).

FIG. 4 is a diagram illustrating elements or components of an example operating environment 400 in which an embodiment of the disclosure may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented or executed at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components (such as one or more electronic processors, microprocessors, central processing units (CPU), or controllers). Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may provide access to multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

A default (or other) user interface may include user interface components enabling a tenant to administer the tenant's access to and use of the functions and capabilities provided by the service platform. This may include accessing tenant data, launching an instantiation of a specific application, or causing the execution of specific data processing operations, as non-limiting examples.

Each application server or processing tier 422 shown in the figure may be implemented with a set of computers and/or components including computer servers and processors, and may perform various functions, methods, processes, or operations as determined by the execution of a software application or set of computer-executable instructions. The data storage tier 424 may include one or more data stores, which may include a Service Data store 425 and one or more Tenant Data stores 426. Data stores may be implemented with a suitable data storage technology, including (as an example) structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize a platform or system provided by a third party. A third party may implement a business system/platform as described in the context of a multi-tenant platform, where individual instantiations of a business' data processing workflow (such as the document processing and document model structure formation disclosed and/or described herein) are provided to users, with each company/business representing a tenant of the platform. One advantage to such multi-tenant platforms is the ability for each tenant to customize their instantiation of the data processing workflow to that tenant's specific business needs or operational methods. Further, each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment of the disclosure may be implemented. In general, an embodiment may be implemented using a set of software instructions that are designed to be executed by a suitably programmed processing element (such as a CPU, microprocessor, processor, controller, or computing device). In a complex system such instructions are typically arranged into “modules” with each such module performing a specific task, process, function, or operation. The entire set of modules may be controlled or coordinated in their operation by an operating system (OS) or other form of organizational platform.

The example architecture 500 of a multi-tenant distributed computing service platform illustrated in FIG. 5 includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture.

Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more associated sub-modules 512. Each application module 511 or sub-module 512 may correspond to a function, method, process, or operation that is implemented by the module or sub-module (e.g., a function or process related to providing data processing and other services to a user of the platform). Such function, method, process, or operation may include those used to implement one or more aspects of the disclosed system and methods, such as for one or more of the processes or functions disclosed and/or described with reference to the specification and Figures:
Perform OCR (optical character recognition) on a PDF file or document scan;
   Based on OCR processing, identify text in the document, and identify bounding boxes for words and lines of that text;
Overlay the text output by the OCR process on top of the original document image (PDF/scan) and make that layer (substantially) invisible to a user. In one embodiment, this may comprise:
   Converting one or more pages into an image representation;
   Computing and applying a scaling factor (if needed) between the image representation and the document scan;
   Identifying and applying a font size and/or type to the text;
   Assembling the text into a layer and overlaying on the PDF or document scan, and making the overlay substantially invisible (or if visible, distinguishable) to the user;
Identify paragraphs in the document by grouping a series of lines together into a section. In one embodiment, this may comprise one or more of the following steps or stages (as mentioned, this is optional and may not be needed if the OCR and associated processing can perform this function):
   Identify spacing between lines and determine the most likely breaks between sections or groups of text;
   Identify enumerators in the document;
   Use the identified breaks and/or enumerators to identify paragraphs in the document;
   If desired, detect headers and/or footers in the document based on position and/or contents (optional);
   Identify and if desired, extract elements such as clause titles and tables for further processing and analysis using one or more of positional and semantic analysis or models (optional);
If necessary, generate and populate a structured document object/model;
   In one embodiment, this may take the form of a model or data structure containing document elements and indicating a relationship between the elements; and
Provide the processed document to a user and/or document processing pipeline for further evaluation and analysis;
   This may include generating a display of the processed document to enable a user to interact with the document by selecting an element of the document, annotating an element, or performing another action.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review (as non-limiting examples).

In addition to the specific example embodiments and use cases disclosed and/or described, there are other uses and contexts in which an embodiment may provide benefits. As a non-limiting example, the disclosed approach or processing flow may serve as a foundation for further enriching a structured representation of a document. For example, a combination of positional and semantic information can be used to detect headers and/or footers (e.g., a section of text located near the top or bottom of a page (and) far from other text (and) short in length, as a possible description or rule for identifying such an element). Separate modules or processes can leverage these two data modalities (positional and semantic) to extract elements such as clause titles or tables (as examples). Once these have been detected/identified, they can be incorporated into the structured document object.

This approach enables valuable functions and capabilities such as directly highlighting the title of a clause. Structured data also improves the process of training a machine learning model because it is less sparse, i.e., a model does not have to learn from scratch what constitutes a header from implicit examples, but it can be shown what is and is not a header.

In addition to the disclosed and/or described embodiments, there are alternative implementation approaches that may provide benefits to users. As non-limiting examples, these may include one or more of:
Performing multiple OCRs and combining the results to obtain higher accuracy;

Although no OCR system or approach is perfect, each is imperfect in somewhat different ways. Ensemble approaches exploit this situation to improve accuracy beyond that of a single system. Using heuristics such as the confidence level returned from the OCR model, membership of the word in a dictionary, or proximity (e.g., via an Edit Distance metric) to a word in a dictionary, a process can select which system's output to return as the “correct” or “best” one.

For example, assume that System A incorrectly identifies a certain character, resulting in the word “legal” with a low confidence score, while System B correctly returns “legal” with high confidence. However, System B gets a different character wrong elsewhere that System A gets right, so one cannot just completely switch from one system to the other. However, one can use the fact that “legal” has lower confidence than “legal” and/or the fact that the latter is present in a dictionary while the former is not to choose the correct form (and so on for other words);
Using a subject matter or industry specific dictionary or thesaurus (such as a legal, electronic, or artificial intelligence specific one) to improve spelling corrections;

Spelling mistakes can occur due to incorrect OCR or a human-generated typo from an original document. Correcting such mistakes can improve the performance of language-based machine learning models, as well as improve a functionality such as search. As an example, legal contracts contain idiosyncratic uses of language that can derail spelling correction approaches geared towards general everyday language. Examples of this include:
Novel words: some legal terms (such as mutatis mutandis) are less likely to be in a general spelling correction dictionary;
Uncommon words: Spelling correction often depends on the statistical likelihood of a word being used. In general English, “arraignment” is not a common word, so if there is an OCR error within that word, a general spelling correction model may incorrectly change it to “arrangement”. A model that reflects the distribution or word usage in legal contracts (as an example) or a typical environment in which the words in a document are expected to occur has a better likelihood of correcting the typo to the appropriate term; or
Uncommon context: Typos sometimes result in words that on their own are still well-formed, e.g., “the cat is out of the bad”. In these cases, the surrounding context may be important to making a correction. However, word meanings and usage patterns differ in legal text (as an example), so a spelling correction model should be trained for the context or environment in which it is expected to be used. For example, “recital” refers to a specific opening section of a contract, but in general English it most commonly refers to an artistic performance.
   For these reasons (and others), a spelling correction system that considers word usage, word distribution, and context is better able to make appropriate corrections for OCR'd text from a specific domain. In some embodiments, an NLP technique or approach that considers context or represents context may be useful (such as ELMo, Embeddings from Language Models) as part of this process.
Using character level confidence to improve spelling corrections;

Some OCR models return a confidence score at the level of individual characters. A relatively high score corresponds to higher certainty of the model that its prediction is correct. As mentioned in the discussion regarding performing multiple OCR models as an ensemble, character confidence level can be used as a heuristic or rule to determine which model's output to select.

Additionally, even with a standalone model, character confidence can be leveraged. Returning to the example of the OCR error “legal”, if the model returns a confidence distribution across the full character set (e.g. “1”: 0.4, “I”: 0.3, “?”: 0.1, “j”:0.1, . . . ), when a word is not present in a dictionary or is determined by a language model to be unlikely given the surrounding context, then the system can replace the most confident character with the second, third, or other most confident one until the resulting word is a better match based on the aforementioned heuristic or rule;
Using different OCRs, for example, one that has a higher accuracy OCR for text and another that has higher accuracy for formatting;

Besides the text content itself, formatting can be important in documents. Formatting such as boldface and italics disproportionally serve to identify key terms such as party names or clause titles (as examples for legal domain text).

Tables may also be important—if an OCR system cannot parse tables differently from regular text, their cells are generally returned in a left to right order. Depending on the orientation of the original table, this can transpose it, separating keys from their values (i.e., Instead of “Start Date: 2/1/23, End Date: 11/1/23”, returning “Start Date: End Date: 2/1/23 11/1/23”). Identifying tables allows a user to explicitly search for tables within a document and retaining the table structure allows downstream algorithms to traverse its cells more accurately and efficiently. From tables, data can be extracted in the form of key-value pairs. In the example above, “Start Date” would be one key, and “2/1/23” would be its corresponding value.

The disclosure includes the following clauses and embodiments:
1. A method for processing a document, comprising:
performing optical character recognition (OCR) processing on a PDF file or document scan to identify text in the document, and to identify bounding boxes for words and lines of that text;
overlaying the text output by the OCR process on top of the original document image and making that layer substantially invisible to a user;
identifying one or more paragraphs in the document by grouping a series of lines together into a paragraph;
generating and populating a structured document object; and
providing the processed document to the user or a document processing pipeline for further evaluation or analysis.
2. The method of clause 1, wherein overlaying the text output by the OCR process on top of the original document image and making that layer substantially invisible to the user further comprises:
converting one or more pages into an image representation;
computing and apply a scaling factor between the image representation and the document scan;
identifying and applying a font type and font size to the text; and
assembling the text into a layer and overlaying on the PDF or document scan and making the overlay substantially invisible to the user.
3. The method of clause 1, wherein identifying one or more paragraphs in the document further comprises:
identifying spacing between lines and determining breaks between sections or paragraphs;
identifying one or more enumerators; and
using the determined breaks and/or enumerators to identify paragraphs in the document.
4. The method of clause 1, further comprising detecting headers and/or footers based on position and/or contents of text.
5. The method of clause 1, further comprising identifying one or more elements for further processing and analysis using one or more of positional and semantic analysis or models.
6. The method of clause 5, wherein the one or more elements identified include clause titles and tables.
7. The method of clause 1, wherein providing the processed document to the user or a document processing pipeline for further evaluation or analysis further comprises generating a display of the processed document to enable a user to interact with the document by selecting an element of the document, annotating an element, or performing another action.
8. A system for processing documents, comprising:
one or more electronic processors configured to execute a set of computer-executable instructions; and
a non-transitory computer-readable medium including the set of computer-executable instructions, wherein when executed, the instructions cause the one or more electronic processors to
   perform optical character recognition (OCR) processing on a PDF file or document scan to identify text in the document, and to identify bounding boxes for words and lines of that text;
   overlay the text output by the OCR process on top of the original document image and make that layer substantially invisible to a user;
   identify one or more paragraphs in the document by grouping a series of lines together into a paragraph;
   generate and populate a structured document object; and
   provide the processed document to the user or a document processing pipeline for further evaluation or analysis.
9. A non-transitory computer readable medium containing a set of computer-executable instructions that when executed by one or more programmed electronic processors, cause the processors to process a document by:
performing optical character recognition (OCR) processing on a PDF file or document scan to identify text in the document, and to identify bounding boxes for words and lines of that text;
overlaying the text output by the OCR process on top of the original document image and making that layer substantially invisible to a user;
identifying one or more paragraphs in the document by grouping a series of lines together into a paragraph;
generating and populating a structured document object; and
providing the processed document to the user or a document processing pipeline for further evaluation or analysis.

The present invention as disclosed and/or described herein can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

The software components, processes, or functions disclosed and/or described in this application may be implemented as software code to be executed by a processor using a suitable computer language such as Python, Java, JavaScript, C, C++, or Perl using conventional or object-oriented techniques. The software code may be stored as a series of instructions or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is a medium suitable for the storage of data or an instruction set aside from a transitory waveform. Such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or devices or forms of memories based on similar technologies. Such computer-readable storage media allow the processing element or processor to access computer-executable process steps and application programs, stored on removable and non-removable memory media, to off-load data from a device or to upload data to a device. As mentioned, with regards to the embodiments disclosed and/or described herein, a non-transitory computer-readable medium may include a structure, technology, or method apart from a transitory waveform or similar medium.

Example embodiments of the disclosure are described herein with reference to block diagrams of systems, and/or flowcharts or flow diagrams of functions, operations, processes, or methods. One or more blocks of the block diagrams, or one or more stages or steps of the flowcharts or flow diagrams, and combinations of blocks in the block diagrams and combinations of stages or steps of the flowcharts or flow diagrams may be implemented by computer-executable program instructions. In some embodiments, one or more of the blocks, or stages or steps may not need to be performed in the order presented or may not need to be performed at all.

The computer-executable program instructions may be loaded onto a general-purpose computer, a special purpose computer, a processor, or other programmable data processing apparatus to produce a specific example of a machine. The instructions that are executed by the computer, processor, or other programmable data processing apparatus create means for implementing one or more of the functions, operations, processes, or methods disclosed and/or described herein. The computer program instructions may be stored in (or on) a non-transitory computer-readable memory that may direct a computer or other programmable data processing apparatus to function in a specific manner, such that the instructions stored in (or on) the computer-readable memory produce an article of manufacture including instruction means that when executed implement one or more of the functions, operations, processes, or methods disclosed and/or described herein.

While embodiments of the disclosure have been described in connection with what is presently considered to be the most practical approach and technology, embodiments are not limited to the disclosed implementations. Instead, the disclosed implementations are intended to include and cover modifications and equivalent arrangements included within the scope of the appended claims. Although specific terms are employed herein, they are used in a generic and descriptive sense only and not for purposes of limitation.

This written description uses examples to describe one or more embodiments of the disclosure, and to enable a person skilled in the art to practice the disclosed approach and technology, including making and using devices or systems and performing the associated methods. The patentable scope of the disclosure is defined by the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference was individually and specifically indicated to be incorporated by reference and/or was set forth in its entirety herein.

The use of the terms “a” and “an” and “the” and similar references in the specification and in the claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Method steps or stages disclosed and/or described herein may be performed in any suitable order unless otherwise indicated herein or clearly contradicted by context.

The use of examples or exemplary language (e.g., “such as”) herein, is intended to illustrate embodiments of the disclosure and does not pose a limitation to the scope of the claims unless otherwise indicated. No language in the specification should be construed as indicating any non-claimed element as essential to each embodiment of the disclosure.

As used herein (i.e., the claims, figures, and specification), the term “or” is used inclusively to refer items in the alternative and in combination.

Different arrangements of the elements, structures, components, or steps illustrated in the figures or described herein, as well as components and steps not shown or described are possible. Similarly, some features and sub-combinations are useful and may be employed without reference to other features and sub-combinations. Embodiments have been described for illustrative and not for restrictive purposes, and alternative embodiments may become apparent to readers of the specification. Accordingly, the disclosure is not limited to the embodiments described in the specification or depicted in the figures, and modifications may be made without departing from the scope of the appended claims.

That which is claimed is:

1. A method for processing a document, comprising:
performing optical character recognition (OCR) processing on a PDF file or document scan to identify text in the document, and to identify bounding boxes for words and lines of that text;
overlaying the text output by the OCR process on top of the original document image and making that layer substantially invisible to a user;
identifying one or more paragraphs in the document by grouping a series of lines together into a paragraph;
generating and populating a structured document object; and
providing the processed document to the user or a document processing pipeline for further evaluation or analysis.

2. The method of claim 1, wherein overlaying the text output by the OCR process on top of the original document image and making that layer substantially invisible to the user further comprises:
converting one or more pages into an image representation;
computing and apply a scaling factor between the image representation and the document scan;
identifying and applying a font type and font size to the text; and
assembling the text into a layer and overlaying on the PDF or document scan and making the overlay substantially invisible to the user.

3. The method of claim 1, wherein identifying one or more paragraphs in the document further comprises:
identifying spacing between lines and determining breaks between sections or paragraphs;
identifying one or more enumerators; and
using the determined breaks and/or enumerators to identify paragraphs in the document.

4. The method of claim 1, further comprising detecting headers and/or footers based on position and/or contents of text.

5. The method of claim 1, further comprising identifying one or more elements for further processing and analysis using one or more of positional and semantic analysis or models.

6. The method of claim 5, wherein the one or more elements identified include clause titles and tables.

7. The method of claim 1, wherein providing the processed document to the user or a document processing pipeline for further evaluation or analysis further comprises generating a display of the processed document to enable a user to interact with the document by selecting an element of the document, annotating an element, or performing another action.

8. A system for processing documents, comprising:
one or more electronic processors configured to execute a set of computer-executable instructions; and
a non-transitory computer-readable medium including the set of computer-executable instructions, wherein when executed, the instructions cause the one or more electronic processors to
perform optical character recognition (OCR) processing on a PDF file or document scan to identify text in the document, and to identify bounding boxes for words and lines of that text;
overlay the text output by the OCR process on top of the original document image and make that layer substantially invisible to a user;
identify one or more paragraphs in the document by grouping a series of lines together into a paragraph;
generate and populate a structured document object; and
provide the processed document to the user or a document processing pipeline for further evaluation or analysis.

9. The system of claim 8, wherein overlaying the text output by the OCR process on top of the original document image and making that layer substantially invisible to the user further comprises:
converting one or more pages into an image representation;
computing and apply a scaling factor between the image representation and the document scan;
identifying and applying a font type and font size to the text; and
assembling the text into a layer and overlaying on the PDF or document scan and making the overlay substantially invisible to the user.

10. The system of claim 8, wherein identifying one or more paragraphs in the document further comprises:
identifying spacing between lines and determining breaks between sections or paragraphs;
identifying one or more enumerators; and
using the determined breaks and/or enumerators to identify paragraphs in the document.

11. The system of claim 8, wherein the instructions cause the one or more electronic processors to detect headers and/or footers based on position and/or contents of text.

12. The system of claim 8, wherein the instructions cause the one or more electronic processors to identify one or more elements for further processing and analysis using one or more of positional and semantic analysis or models.

13. The system of claim 12, wherein the one or more elements identified include clause titles and tables.

14. The system of claim 8, wherein providing the processed document to the user or a document processing pipeline for further evaluation or analysis further comprises generating a display of the processed document to enable a user to interact with the document by selecting an element of the document, annotating an element, or performing another action.

15. A non-transitory computer readable medium containing a set of computer-executable instructions that when executed by one or more programmed electronic processors, cause the processors to process a document by:
performing optical character recognition (OCR) processing on a PDF file or document scan to identify text in the document, and to identify bounding boxes for words and lines of that text;
overlaying the text output by the OCR process on top of the original document image and making that layer substantially invisible to a user;
identifying one or more paragraphs in the document by grouping a series of lines together into a paragraph;
generating and populating a structured document object; and
providing the processed document to the user or a document processing pipeline for further evaluation or analysis.

16. The non-transitory computer readable medium of claim 15, wherein overlaying the text output by the OCR process on top of the original document image and making that layer substantially invisible to the user further comprises:
converting one or more pages into an image representation;
computing and apply a scaling factor between the image representation and the document scan;
identifying and applying a font type and font size to the text; and
assembling the text into a layer and overlaying on the PDF or document scan and making the overlay substantially invisible to the user.

17. The non-transitory computer readable medium of claim 15, wherein identifying one or more paragraphs in the document further comprises:
identifying spacing between lines and determining breaks between sections or paragraphs;
identifying one or more enumerators; and
using the determined breaks and/or enumerators to identify paragraphs in the document.

18. The non-transitory computer readable medium of claim 15, wherein the instructions cause the one or more electronic processors to detect headers and/or footers based on position and/or contents of text.

19. The non-transitory computer readable medium of claim 15, wherein the instructions cause the one or more electronic processors to identify one or more elements for further processing and analysis using one or more of positional and semantic analysis or models.

20. The non-transitory computer readable medium of claim 19, wherein the one or more elements identified include clause titles and tables.

21. The non-transitory computer readable medium of claim 15, wherein providing the processed document to the user or a document processing pipeline for further evaluation or analysis further comprises generating a display of the processed document to enable a user to interact with the document by selecting an element of the document, annotating an element, or performing another action.
